(19) United States
(12) Patent Application Publication
(10) Pub. No.: US 2009/0144997 A1
(43) Pub. Date: Jun. 11, 2009

(54) CLUB HEAD MEASURING GAUGE

(76) Inventor: Kuen-Yi WANG, Ta Liao Hsiang (TW)

Correspondence Address: SINORICA, LLC, 528 FALLSGROVE DRIVE, ROCKVILLE, MD, 20850, US

(21) Appl. No.: 11/950,532

(22) Filed: Dec. 5, 2007

(51) Int. Cl. G01B 1/00

(52) U.S. Cl. 33/508

(57) ABSTRACT

The present invention relates to a kind of club head measuring gauge, thereat a clamping bar device, a lie angle protractor, and a loft measuring gauge are installed at the base respectively, wherein, the said clamping bar device has been firmly fixed with the said lie angle protractor and hence moving all together at the same time, and more over, the said clamping bar device is being used to fasten the club head which needs to be measured, and while the transparent reference board is being evenly stayed close to the impact face of the club head in such a way that the reference line at the transparent measuring plate is being aligned with the ball-impacting line on the impact face of said club head, then in this way, it will be able to acquire the measuring data for a lie angle at the same time when there is a movement for the measuring gauge block generated and driven by the golf club, and thus, it will be able to fulfill the objective successfully by measuring both the loft and lie angles synchronously.

### BACKGROUND OF THE INVENTION

1. Field of the Invention

The present invention relates generally to a kind of club head measuring gauge, which primarily consists of a clamping bar device, a lie angle protractor, and a loft measuring gauge installed at the base respectively, wherein, the clamping bar device has been firmly fixed with the lie angle protractor and hence moving all together at the same time.

2. The Prior Arts

Generally, the structure of a traditional club head angle measuring gauge has installed several measuring devices at its base (as described in previous invention of U.S. Pat. No. 4,928,397), and then utilizing each measuring device installed at the base to measure various angles of such club head individually, however, the measuring procedure for a club head of this kind of traditional measuring device is very complex, thereat, it is required to fix the club head firstly, and then move such measuring device toward a measuring position of the club head in order to perform the angle measurement procedure, and in addition, upon the measuring operation, it needs to adjust the turning knob, move the position of such club head in order to acquire the data of angle respectively, therefore, it is very inconvenient in measuring procedure as well as structure of measuring device along with the problems as follows:

First, because the traditional club head measuring gauge has installed all measuring devices at its base, therefore, it will cause the traditional club head measuring gauge having a relative large volume, thereat, it is not only very inconvenient in operation but also having a much lower competition capability due to a high production cost.

Second, it is required for a tradition measuring gauge to adjust its measuring procedure with a particular measuring device in advance and under this circumstance, it will take a much longer time and working time in measuring the angle of a club head, therefore, it is very complex as well as ineffective time consumption.

### SUMMARY OF THE INVENTION

The present invention relates to a kind of club head measuring gauge, which primarily consists of a clamping bar device, a lie angle protractor, and a loft measuring gauge installed at the base respectively, wherein the clamping bar device is connected to a top portion of the measuring gauge block of such lie angle protractor with a slide rail so that it is allowable to move freely; and in addition, the end portion of the measuring gauge block of such lie angle protractor has been firmly fixed at the center of the dial gauge, so that the measuring gauge block would be driven and move according to the club angle adjusted in the clamping bar device, and hence show up the data of a lie angle by means of an arch displacement in the range of such dial gauge; again, the loft measuring gauge has a rotary axle fixed at the center of such dial gauge, and thereat such rotary axle is additionally equipped with a transparent measuring plate so that the dial gauge will show up the data of a loft angle with a needle according to the arch displacement of such transparent measuring plate. Upon the measuring procedure, it mainly needs to use the clamping bar device to fasten the club so that the transparent measuring plate of such loft measuring gauge is able to stay close to the impact face of the club head so as to display an angle by moving the needle on said dial gauge correspondingly, and hence acquire the data of the loft angle accordingly, and while the reference line at the transparent measuring plate is being aligned with the ball-impacting line at the impact face of said club head, then in this way, it will be able to acquire the measuring data for the lie angle at the same time when there is a movement for the measuring gauge block generated and driven by the golf club, and thus, it will be able to fulfill the objective successfully by measuring both the loft and lie angles synchronously.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a stereographic exploded view of the present invention;

FIG. 2 is a stereographic assembly view of the present invention;

FIG. 3 is the front view of the present invention;

FIG. 4 is a schematic view showing the moving status of the present invention;

FIG. 5 is a schematic view showing the angle measuring procedure of the present invention; and

FIG. 6 is a schematic view which shows the accomplished status of angle measurement in accordance with the present invention.

### DETAILED DESCRIPTION OF THE PREFERRED EMBODIMENT

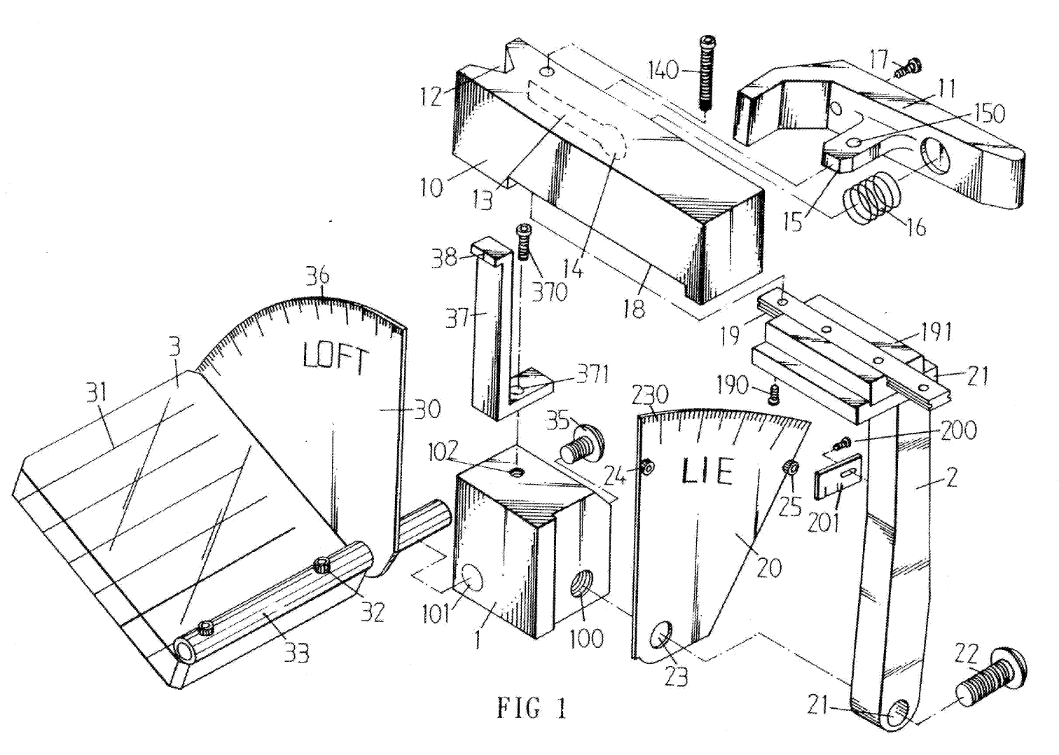

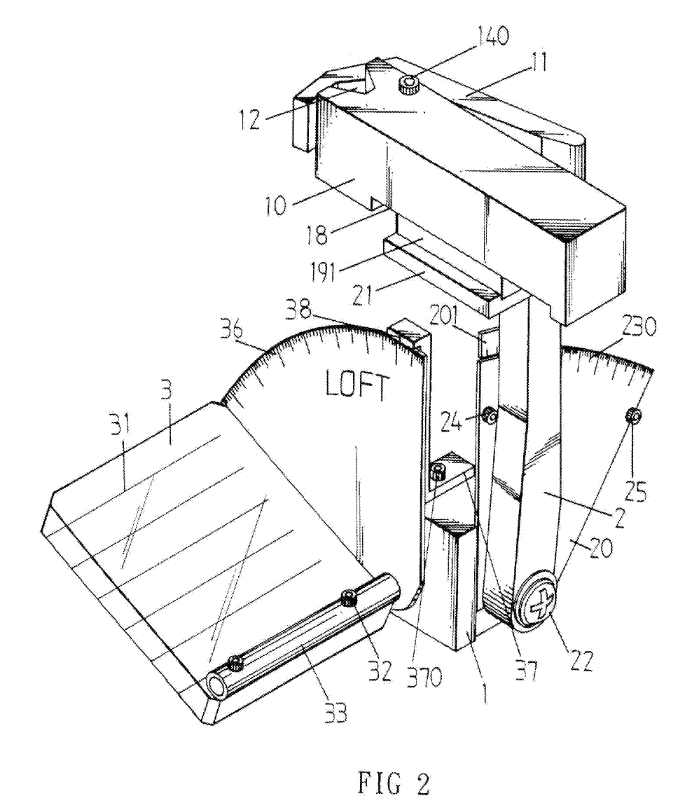

With reference to FIG. 1 and 2, which shows the structure of a club head measuring gauge according to the present invention, which primarily consists of a clamping bar device, a lie angle protractor, and a loft measuring gauge installed at the base 1 respectively; wherein, the clamping bar device comprises the fixed base 10 and a clamping bar 11, and thereat, there is a recessed slot 12 positioned at a side end of such fixed base 10, and furthermore, a square slot 13 and a round slot 14 are positioned at its back end respectively so as to operate correspondingly, while the clamping bar 11 is being penetrated with a connecting bar 15 and then using a screw bar 140 to penetrate into a penetration hole 150 of such connecting bar 15 so as to act as a rotary axle thereof, and in this way, the clamping bar 11 will be driven and hence having an arch displacement, and more over, the said round slot 14 is going to receive a spring 16 which is being connected to an area between said clamping bar 11 and fixed base 10, so that it is available to utilize the rebound force generated by the said clamping bar 11 to control the clamping strength and distance between the recessed slot 12 and said clamping bar 11, while an adjusting screw 17 which is penetrating through said clamping bar 11 and pushing against the said fixed base 1 in order to adjust and control the clamping distance of said clamping bar 11 at the same time, in addition, there is an recessed slot 18 positioned at a bottom end of said fixed base 1 so as to install and fasten the slide rail 19 with a screw 190; and thereat, while it is being coupled with a slide rail base 191 of said lie angle protractor, it will make the said clamping bar device to move left to right or vice versa.

The lie angle protractor comprises a measuring gauge block 2 and a dial gauge 20, wherein, a fixed base 21 is integrated and extended from the top end of such measuring gauge block 2, thereat the fixed base 21 is allowable to be installed with the slide rail base 191 and hence said clamping bar device is able to move correspondingly while there is a slide rail 19 being integrated into the slide rail base 191, and more over, a needle plate 201 is installed at the middle portion of measuring gauge block 2 which is fastened with a screw 200 thereto, in addition, there is a penetration hole 21 positioned at its lower end so that it is available to fasten said dial gauge 20 at a screw hole 100 on said base 1 along with a penetration hole 23 positioned at a lower end of said dial gauge 20 by means of a fixing screw 22; furthermore, the said dial gauge 20 has graduations 230 on its face, and there are position-limited blocks 24, 25 equipped at both sides of said dial gauge 20 in order to limit the displacement range of said measuring gauge block 2.

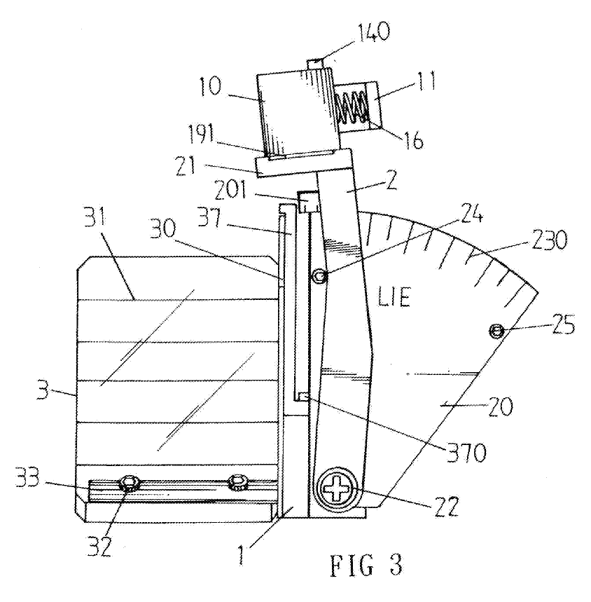

The loft measuring gauge comprises a transparent measuring plate 3 and a dial gauge 30, and wherein said transparent measuring plate 3 is a kind of transparent block, which has reference line 31 in its lower surface, and then it is integrated with a rotary axle 33 at the top end of its lower end with a fixing screw 32, and thereat, the said rotary axle 33 is penetrating through a central penetration hole 34 at the said dial gauge 30 as well as extending outward, and also penetrating into a penetration hole 101 of base 1, and then being fixed by the fixing screw 35, so that both transparent measuring plate 3 and dial gauge 30 will revolve along with the rotary axle 33 and hence create an arch displacement in such a way that it will make the graduation 36 on said dial gauge 30 to align against the needle 38 of the needle base 37 accordingly; due to the said needle base 37 has a L-shape structure, therefore, the said needle base 37, which is fastened at a screw hole 102 of said base 1 by means of a screw 370 and a penetration hole 371, will revolve corresponding to the dial gauge 30 and hence making the graduation 36 to align against the needle 38 and show up the data of a loft angle thereof, and in this way, it will be able to construct the integrated structure of said measuring gauge by assembling each above said component onto the said base 1 (as shown in FIG. 3).

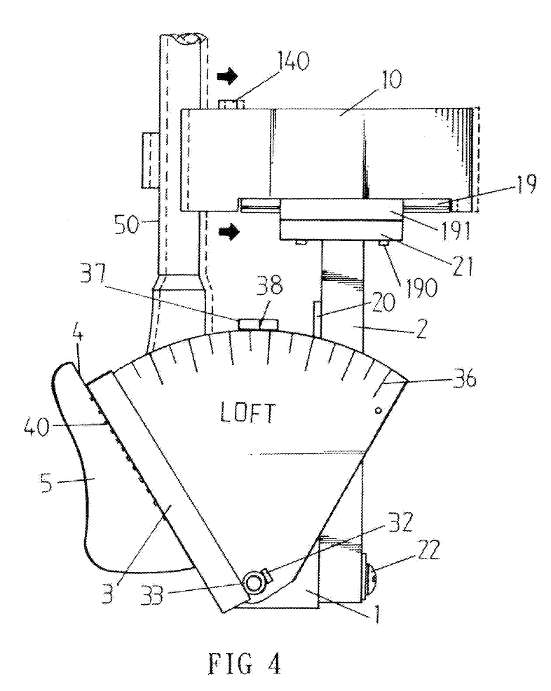

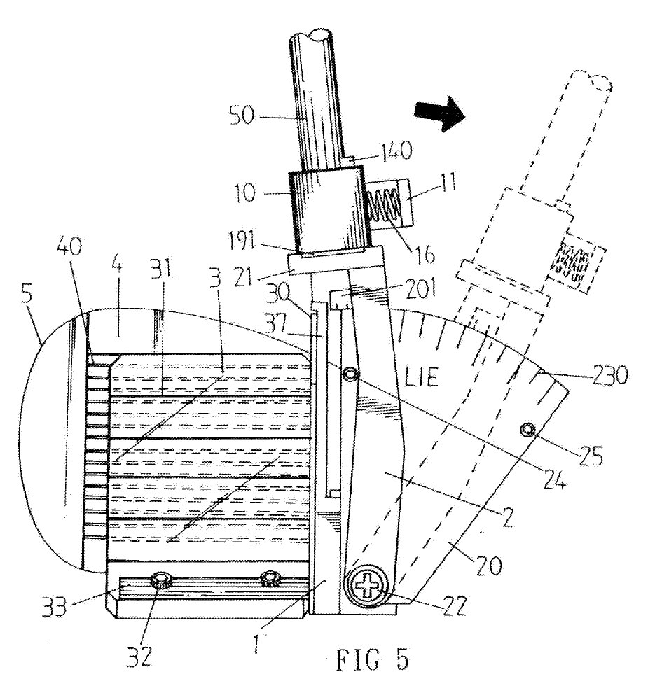

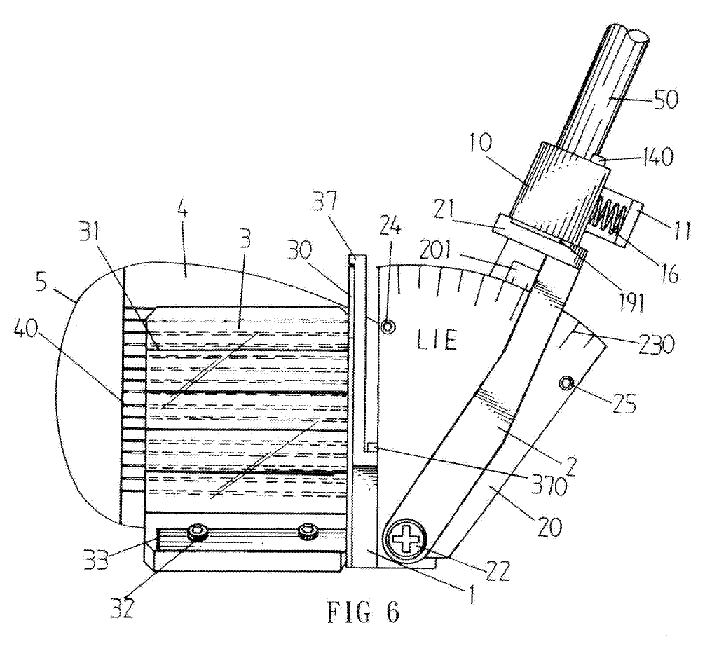

Hereby, upon the measuring procedure, with reference to FIG. 4, it mainly needs to make the transparent measuring plate 3 of the loft measuring gauge to stay close to the impact face 4 of a club head in such a way that graduation 36 at dial gauge 30 would be able to correspond to the needle 38 of said needle base 37, and in this way, while having the reference line 31 at the transparent measuring plate 3 aligned with the horizontal line 40 at the impact face 4 of said club head 5, it will generate a displacement for the club 50 with such club head 5 and hence driving the fixed base to move aside and meanwhile driving the said measuring gauge block 2 to move backward (as shown in FIG. 5), and therefore, and by the time while the transparent measuring plate 3 is staying close to the impact face 4 of the club head, and meanwhile the horizontal line is aligning with the reference line 31 at the transparent measuring plate 3, then in this way, the graduation on the dial gauge 30 would be corresponding to needle 38 and hence making a displacement of measuring gauge block 2 which is being driven by the club 50, and meanwhile, the needle plate fixed on it would be corresponding against the graduation 230 of said dial gauge 20 so that it will be able to acquire the measuring data for a lie angle of said club head at the same time (as shown in FIG. 6), and thus, it will be able to fulfill the objective successfully by measuring both the loft and lie angles synchronously.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A club head measuring gauge, being used to measure both the loft angle and lie angle of a club head, which primarily consists of a clamping bar device, a lie angle protractor, and a loft measuring gauge installed at the base respectively, wherein:
said clamping bar device having a fixed base and a clamping bar, in which, there is a recessed slot positioned at a front end of the fixed base, the side end of said fixed base is connected to an area between the fixed base and the clamping bar with a spring in order to control said clamping bar to fasten the club which needs to be measured along with the said recessed slot;
said lie angle protractor comprises a measuring gauge block and a dial gauge, wherein, a fixed base is integrated and extended from the top end of the measuring gauge block, thereat it is connected to the clamping bar device with a slide rail structure so that it is movable therefrom; the bottom end of such measuring gauge block is fastened, along with the dial gauge, to said base by means of a fixing screws in such a way that the said measuring gauge block will be able to move in the available range of the dial gauge, and hence allowable to measure the lie angle by a needle plate installed at measuring gauge block which is operating correspondingly to said dial gauge;
said loft measuring gauge comprises a transparent measuring plate, a dial gauge and a rotary axle, wherein, the transparent measuring plate is firmly fixed at the side edge of the dial gauge, and there is a reference line positioned at its bottom end, and thereat, the rotary axle is fixed to a bottom edge of said transparent measuring plate and then penetrating through the dial gauge and reaching to its full length, so that the said rotary axle will be revolvable at the base and hence to measure a loft angle by operating together with needle base correspondingly; and
hereby, it mainly needs to make the transparent measuring plate to stay close to the impact face of a club head so as to acquire the data of the loft angle while having the reference line at the transparent measuring plate aligned with the horizontal line at the impact face of said club head, and in this way, it will be able to acquire the measuring data for both the lie angle and the loft angle synchronously when there is a movement for the measuring gauge block generated and driven by the golf club.

2. The club head measuring gauge as claimed in claim 1, wherein the dial gauge of said lie angle protractor has the position-limited blocks installed at the edges of both sides.

3. The club head measuring gauge as claimed in claim 1, wherein the bottom base of the needle base of said loft measuring gauge is firmly fixed to its base, the needle at the top end is positioned at the edge of said dial gauge.

4. The club head measuring gauge as claimed in claim 1, wherein the needle plate of said lie angle protractor is positioned at the corresponding position of measuring gauge block locating at an upper edge of said dial gauge.
